(19) United States
(12) Patent Application Publication
(10) Pub. No.: US 2005/0068921 A1
(43) Pub. Date: Mar. 31, 2005

(54) Multiplexing of physical channels on the uplink

(76) Inventor: Jung-Tao Liu, Madison, NJ (US)

Correspondence Address: HARNESS, DICKEY & PIERCE, P.L.C., P.O. Box 8910, Reston, VA, 20195, US

(21) Appl. No.: 10/671,672

(22) Filed: Sep. 29, 2003

(51) Int. Cl. H04B 7/216

(52) U.S. Cl. 370/335

(57) ABSTRACT

In a method for multiplexing information from a plurality of physical channels for uplink transmission, information on the plurality of physical channels may be subject to code multiplexing to generate a code-multiplexed signal for uplink transmission. The code multiplexing may include subjecting the information on the physical channels to a channelization operation. Information from at least one of the physical channels may be serial-to-parallel converted and mapped to one or both of a first branch and a second branch for the channelization operation.

### RELATED APPLICATIONS

This application is related to the following co-pending U.S. Patent applications: U.S. application Ser. No. 10/647,339 to Jung-Tao LIU, filed Aug. 26, 2003 and entitled “Method and Control Channel for Uplink Signaling in a Communication System”; and U.S. application Ser. No. (Unassigned, Attorney Docket No. 29250-001073/US) to Jung-Tao LIU, filed Sep. 29, 2003 and entitled “Method of Aligning Physical Channels for Uplink Transmission”. The contents of each of the above co-pending applications are incorporated by reference in their entirety herein.

### BACKGROUND OF THE INVENTION

1. Field of the Invention

The present invention relates to telecommunications, and more particularly, wireless communications.

2. Description of Related Art

Expanded efforts are underway to support the evolution of the Universal Mobile Telecommunications System (UMTS) standard, which describes a network infrastructure implementing a next generation Wideband Code Division Multiple Access (W-CDMA) air interface technology. A UMTS typically includes a radio access network, referred to as a UMTS terrestrial radio access network (UTRAN). The UTRAN may interface with a variety of separate core networks (CN). The core networks in turn may communicate with other external networks (ISDN/PSDN, etc.) to pass information to and from a plurality of wireless users, or user equipments (UEs), that are served by radio network controllers (RNCs) and base transceiver stations (BTSs, also referred to as Node Bs), within the UTRAN, for example.

Standardizing bodies such as the 3rd Generation Partnership Project (3GPP and 3GPP2), a body which drafts technical specifications for the UMTS standard and other cellular technologies, have introduced several advanced technologies and enhancements in an effort to ensure that any associated control information is carried in an efficient manner. Certain advanced or enabling technologies may include fast scheduling, Adaptive Modulation and Coding (AMC) and Hybrid Automatic Repeat Request (HARQ) technologies. These technologies have been introduced in an effort to improve overall system capacity.

While much of the standardization to date has focused on the downlink (forward link from Node B/base station to UE/mobile station), similar enhancements are now being considered for the uplink (reverse link) to provide services such as High Speed Downlink Packet Access (HSDPA) services. Further evolution of 3G standards include the development of enhanced uplink (EU) features, which may be referred to as enhanced uplink dedicated channel (EU-DCH) services, to support high-speed reverse link packet access (uplink from mobile station to base station). Many of the techniques used in the forward link (i.e., fast scheduling, AMC, HARQ, etc.) thus may also be usable on the reverse link, so as to improve data rates, improve system capacity, and reduce system costs, for example.

A physical channel is an entity used to carry information between the physical layers, or bottom layer of the open system interface (OSI) model, at two different devices, such as a base station (Node B), mobile station (UE). The physical channel is directly transmitted over a communication media such as open air, optical fiber, etc. Currently in UMTS, there are three types of uplink dedicated physical channels employed for transmission of control information and data in the uplink: the uplink Dedicated Physical Data Channel (uplink DPDCH), the uplink Dedicated Physical Control Channel (uplink DPCCH), and the uplink Dedicated Control Channel associated with HS-DSCH transmission (uplink HS-DPCCH). These uplink dedicated physical channels are l/Q code multiplexed to provide a code multiplexed signal that is input to an amplifier for transmission on the uplink. With the development of EU-DCH services, however, new uplink dedicated physical channels, in addition to the existing physical channels, may have to be considered and/or developed to support proposed EU features.

### SUMMARY OF THE INVENTION

An exemplary embodiment of the present invention is directed to a method for multiplexing information from a plurality of physical channels for uplink transmission. Information on the plurality of physical channels may be subject to code multiplexing to generate a code-multiplexed signal for uplink transmission. The code multiplexing may include subjecting the information on the physical channels to a channelization operation. Information from at least one of the physical channels may be serial-to-parallel converted and mapped to one or both of a first branch and a second branch for the channelization operation.

Another exemplary embodiment of the present invention is directed to a method of multiplexing information on a plurality of physical channels for uplink transmission, where the plurality of physical channels include a data channel. The Information on the physical channels may be subjected to a channelization operation to generate one of real-valued (I) spread signals on an I branch and imaginary-valued (Q) spread signals on a Q branch. Data symbols from the data channel may be serial-to-parallel converted and mapped to one of the I branch and Q-branch for the channelization operation. The spread signals on the I and Q branches may be summed as a complex-valued signal that is subjected to scrambling in order to generate a code-multiplexed signal for uplink transmission.

### BRIEF DESCRIPTION OF THE DRAWINGS

Exemplary embodiments of the present invention will become more fully understood from the detailed description given herein below and the accompanying drawings, wherein like elements are represented by like reference numerals, which are given by way of illustration only and thus do not limit the exemplary embodiments of the present invention and wherein:

FIG. 1 illustrates a high-level diagram of the UMTS architecture, in accordance with an exemplary embodiment of the invention.

FIG. 2A illustrates the frame structure of a conventional uplink DPDCH and uplink DPCCH.

FIG. 2B illustrates the frame structure of a conventional uplink HS-DPCCH.

FIG. 3 illustrates an exemplary general structure of an EU-DPCCH sub-frame in accordance with the exemplary embodiments of the invention.

FIG. 4 illustrates spreading for uplink dedicated physical channels in accordance with the exemplary embodiments of the invention.

### DETAILED DESCRIPTION OF EXEMPLARY EMBODIMENTS

Although the following description of the present invention is based on the Universal Mobile Telecommunications System (UMTS) network infrastructure implementing a next generation Wideband Code Division Multiple Access (W-CDMA) air interface technology, it should be noted that the exemplary embodiments shown and described herein are meant to be illustrative only and not limiting in any way. As such, various modifications will be apparent to those skilled in the art. For example, it will be understood that the present invention finds application to any medium access control protocol with multiple modes in other spread spectrum systems such as CDMA2000 systems.

Where used below, base transceiver station (BTS) and Node-B are synonymous and may describe equipment that provides data connectivity between a packet switched data network (PSDN) such as the Internet, and one or more mobile stations. Additionally where used below, the terms user, user equipment (UE), subscriber, mobile station and remote station are synonymous and describe a remote user of wireless resources in a wireless communication network.

In general, the exemplary embodiments of the present invention are directed to methods for multiplexing information from a plurality of uplink dedicated physical channels, such as dedicated physical control channels (DPCCHs) and dedicated physical data channels (DPDCHs). The exemplary embodiments of the present invention provide methods of multiplexing or spreading the physicals channels in the uplink, so as to accommodate existing DPCCHs/DPDCHs), high speed channels such as HS-DPCCHs that support HSPDA services, and newly developed physical channels that may support EU-DCH services. Accordingly, the exemplary embodiments introduce an uplink control channel for carrying control signal data in the uplink from a user, referred to as an Enhanced Uplink Dedicated Physical Control Channel (EU-DPCCH), and its associated data channel, the Enhanced Uplink Dedicated Physical Data Channel (EU-DPDCH). The EU-DPCCH and EU-DPDCH are envisioned for enhanced uplink (EU) features to support high-speed reverse link packet access in UMTS, although the exemplary embodiments are not limited for application to high-speed reverse link packet access in UMTS.

The EU-DPCCH and EU-DPDCH are physical channel. The EU-DPCCH may be physically embodied by a sub-frame structure, each sub-frame including a plurality of slots, each slot including one of more fields. There may be up to n EU-DPDCHs corresponding to a single EU-DPCCH; but there is only one EU-DPCCH for a user. Initially an exemplary wireless communication network architecture is described, as are general functions of dedicated uplink physical channels, to place the exemplary embodiments in context.

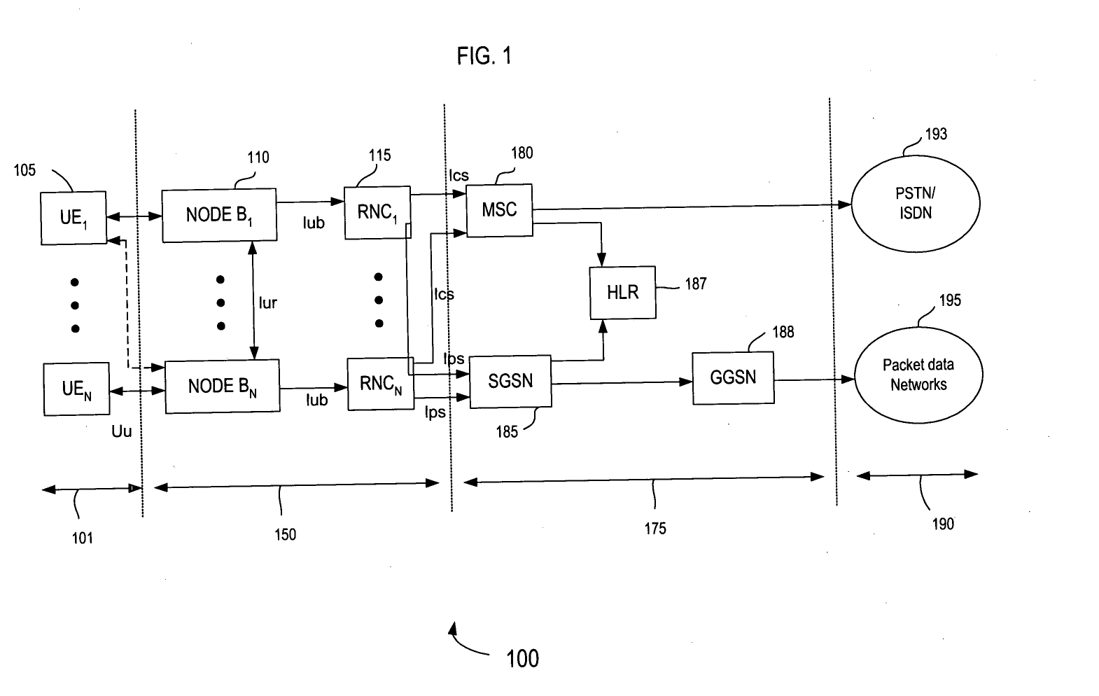

FIG. 1 illustrates a high-level diagram of the UMTS architecture, in accordance with an exemplary embodiment of the invention. This UMTS architecture is provided merely as an exemplary network or system architecture, it being understood that the EU-PDCCH could be applicable to other spread spectrum systems such as CDMA2000 systems.

Referring to FIG. 1, a UMTS architecture 100 comprises a radio access network part that may be referred to as a UMTS terrestrial radio access network (UTRAN) 150. The UTRAN 150 interfaces over a Uu air interface with a radio interface part 101; namely user equipments (UEs) such as mobile stations. The Uu air interface is the radio interface between the UTRAN 150 and one or more UEs 105. The UTRAN 150 also interfaces with one or more core networks (CNs) 175 (only one being shown in FIG. 1 for simplicity) via interfaces Ics and Ips, for example. Ics, short for Interface Unit (Circuit Switched) interface, is the interface in UMTS which links the RNC with a Mobile Switching Center (MSC). Ips, short for Interface Unit (Packet Switched) interface, is the interface in UMTS which links the RNC with a Serving GPRS Support Node (SGSN). The Uu air interface enables interconnection of Node Bs with UEs, for example.

CN 175 may include mobile switching centers (MSCs) 180, SGSNs 185 and Gateway GPRS serving/support nodes (GGSNs) 188. SGSN 185 and GGSN 188 are gateways to external networks 190. In general in UMTS, SGSNs and GGSNs exchange packets with mobile stations over the UTRAN, and also exchange packets with other internet protocol (IP) networks, referred to herein as “packet data networks”. External networks 190 may include various circuit networks 193 such as a packet Switched Telephone Network (PSTN) or Integrated Service Digital Network (ISDN) and packet data networks 195. UTRAN 150 may also be linked to the CN 175 via back-haul facilities (not shown) such as T1/E1, STM-x, etc., for example.

The UTRAN 150 may include cell sites, called Node Bs 110, which may serve a group of UEs 105, generally using a Uu interface protocol. A Node B 110 may contain radio transceivers that communicate using lub protocol with radio network controllers (RNCs) 115 in UTRAN 150. RNCs 115 within UTRAN 150 may communicate with each other using an lur protocol, for example. The lur air interface is a subset of the lu interface that enables interconnection of RNCs with each other. Several Node Bs 110 may interface with a single RNC 115 where, in additional to call setup and control activity, tasks such as radio resource management and frame selection in soft handoff may be carried out. Node Bs 110 and RNCs 115 may be connected via links that use ATM-based packet transport, for example.

Dedicated Physical Channels in the Uplink

The EU-DPCCH and EU-DPDCH are physical channels. In general, physical channels are defined by a specific carrier frequency, scrambling code, channelization code (optional), time start and stop (giving a duration) and, on the uplink, relative phase (0 or π/2). Time durations are defined by start and stop instants, measured in integer multiples of chips. Suitable multiples of chips include a radio frame, a slot (known also as a timeslot) and a sub-frame. A radio frame is a processing duration which consists of 15 slots. The length of a radio frame typically corresponds to 38400 chips. A slot is a duration which consists of fields containing bits. The length of a slot corresponds to 2560 chips. In general, a sub-frame is a basic time interval for a High Speed Downlink Shared Channel (HS-DSCH) transmission and HS-DSCH-related signaling at the physical layer (Layer 1). The HS-DSCH is a downlink transport channel shared by several UEs. The length of a sub-frame typically corresponds to 3 slots (7680 chips).

Existing Physical Channels

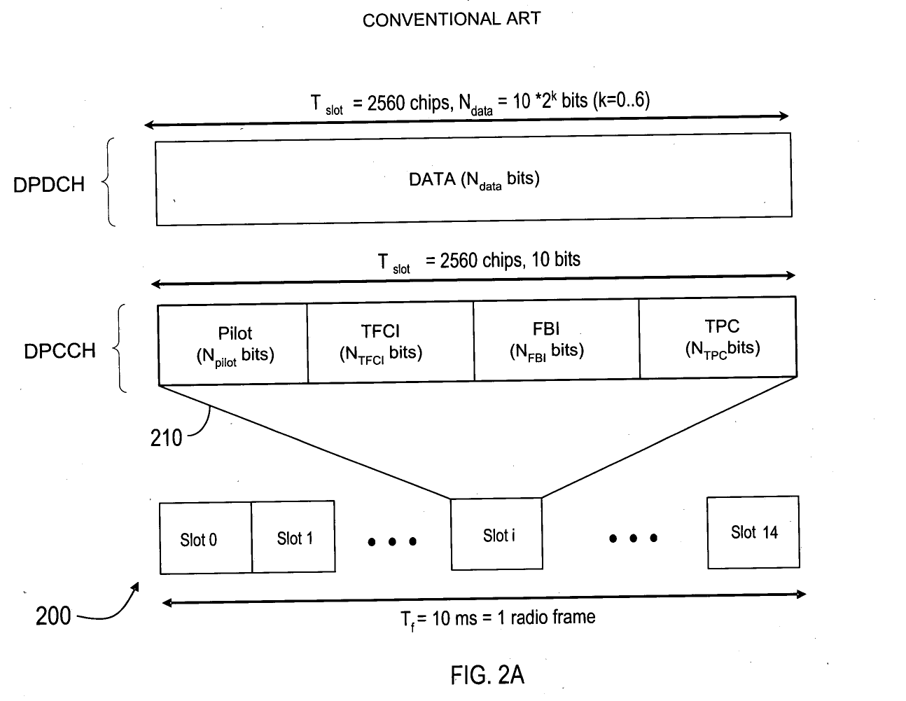

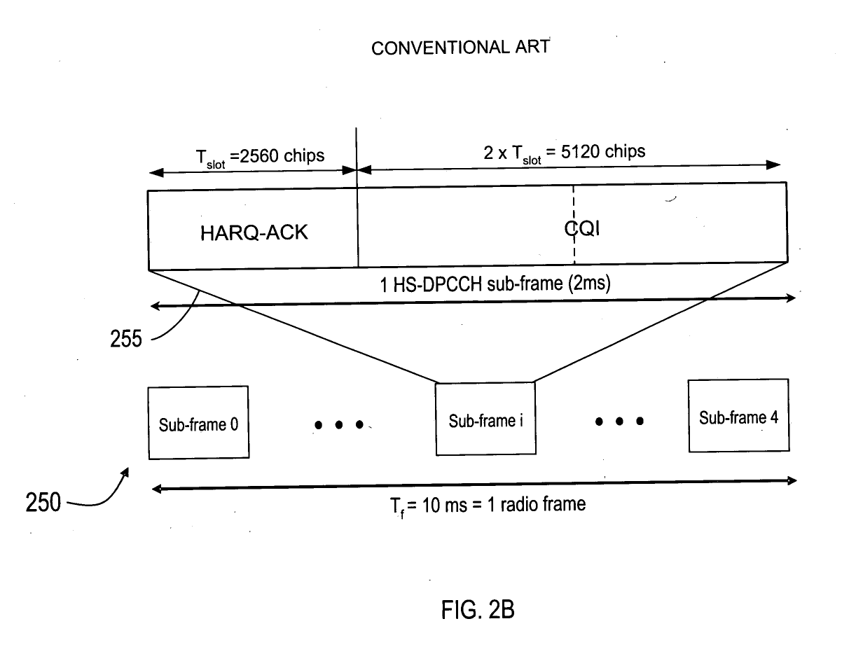

FIG. 2A illustrates the frame structure of a conventional uplink DPDCH and uplink DPCCH. This frame structure is described in detail in 3GPP TS 25.211 V5.3.0, entitled “3rd Generation Partnership Project; Technical Specification and Group Radio Access Network; physical channels and mapping of transport channels onto physical channels (FDD) (Release 5)”, December 2002. Although this document has not been implemented in the standard, the frame structure provides a context for the following general discussion of dedicated physical channels.

Conventionally in UMTS, there are three types of uplink dedicated physical channels, the uplink Dedicated Physical Data Channel (uplink DPDCH), the uplink Dedicated Physical Control Channel (uplink DPCCH), and the uplink Dedicated Control Channel associated with HS-DSCH transmission (uplink HS-DPCCH). The DPDCH, the DPCCH and the HS-DPCCH are I/Q code multiplexed. The uplink DPDCH is used to carry the DCH transport channel (a transport channel of services offered by Layer 1 (physical layer) to the higher layers (OSI Layers 3-7). There may be zero, one, or several uplink DPDCHs on each radio link. As described in 3GPP TS 25.211 V5.3.0, transport channels are capable of being mapped to physical channels. Within the physical layer itself the exact mapping is from a composite coded transport channel (CCTrCH) to the data part of a physical channel. In other words, DCHs are coded and multiplexed and the resulting stream is mapped sequentially (first-in-first-mapped) via the CCtrCH directly to the physical channels (e.g., DPDCH, DPCCH).

The conventional uplink DPCCH is used to carry control information generated at Layer 1. The Layer 1 control information consists of known pilot bits to support channel estimation for coherent detection, transmit power-control (TPC) commands, feedback information (FBI), and an optional transport-format combination indicator (TFCI). The TFCI informs the receiver about the instantaneous transport format combination of the transport channels mapped to the simultaneously transmitted uplink DPDCH radio frame.

Referring now to FIG. 2A, Each radio frame 100 of length (Transmission Time Interval (TTI)) 10 ms is split into fifteen (15) slots 110, each of length Tₛₗₒₜ=2560 chips, corresponding to one power-control period. There is one DPCCH on each radio link. The DPDCH and DPCCH are frame aligned with each other.

The parameter k in FIG. 2A determines the number of bits per uplink DPDCH slot, and is related to the spreading factor SF of the DPDCH as SF=256/2^{k}. The DPDCH spreading factor may range from 256 down to 4. The spreading factor of the uplink DPCCH is equal to 256, i.e. there are 10 bits per uplink DPCCH slot. The exact number of bits of the uplink DPDCH and the different uplink DPCCH fields (Nₚᵢₗₒₜ, N_{TFCI}, N_{FBI}, and N_{TPC}) is specified in Section 5.2 of 3GPP TS 25.211, V5.3.0. What slot format to use is configured by higher layers and can also be reconfigured by higher layers. As will be described in further detail below, multi-code operation is possible for the uplink dedicated physical channels. When multi-code transmission is used, several parallel DPDCHs are transmitted using different channelization codes. However, there is typically only one DPCCH per radio link.

FIG. 2B illustrates the frame structure of a conventional HS-DPCCH. The HS-DPCCH carries uplink feedback signaling related to downlink HS-DSCH transmission. The HS-DSCH-related feedback signaling consists of Hybrid-ARQ Acknowledgement (HARQ-ACK) and Channel-Quality Indication (CQI). Each sub-frame 250 of length 2 ms (3*2560 chips) consists of three slots 255, each of length 2560 chips. The HARQ-ACK is carried in the first slot 255 of the HS-DPCCH sub-frame. The CQI is carried in the second and third slots 255 of sub-frame 250. There is at most one HS-DPCCH on each radio link. The HS-DPCCH may only exist together with an uplink DPCCH.

Proposed Uplink Dedicated Channels: EU-DPCCH and EU-DPDCH

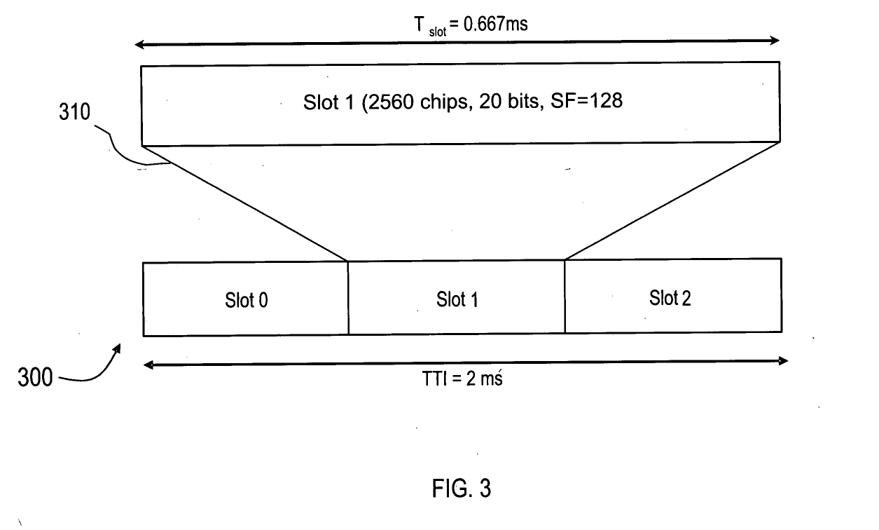

FIG. 3 illustrates an exemplary general structure of an EU-DPCCH sub-frame in accordance with the exemplary embodiments of the invention. The structure of the EU-DPDCH may be similar to the EU-DPCCH, thus a discussion of the EU-DPCCH is provided for reasons of brevity, it being understood that the sub-frame structure may also be applicable for the EU-DPDCH.

The EU-PDCCH is designed to support Enhanced Uplink (EU) features in UMTS and is associated with its uplink data channel, EU-DPDCH, to carry necessary control information on the uplink. Although not a focus in the present invention, and as it has been described in detail in co-pending U.S. Patent applications: U.S. application Ser. No. 10/647,339 to the inventor, the EU-DPCCH may be used to send control signaling information for packet data (such as high speed data) on the uplink when a UE is configured in both a scheduled transmission mode and a rate-controlled transmission mode. These modes are described briefly below, and are described in greater detail in the '339 application.

Referring to FIG. 3, a sub-frame 300 of an EU-DPCCH (or EU-DPDCH) is illustrated. The sub-frame 300 is shown having a fixed transmission time interval (TTI) of 2 ms, it being understood that 2 ms is an exemplary TTI. Other fixed TTI lengths may be applicable, such as 3.3 ms, 4 ms, 6 ms and 8 ms, or a variable TTI length, depending on the desired implementation. Accordingly, the TTI length may be adapted for a desired channel design.

Each sub-frame 300 may include three slots 310 (Slot 0, Slot 1 and Slot 2), each of a duration (Tₛₗₒₜ) 0.667 ms each (Tₛₗₒₜ=2560 chips=0.667 ms, 2*10*k bits (k=256/SF)). Although not shown, information, which may be control signaling information or data such as packet data in each slot 210 may be transmitted over multiple channelization code slots. The EU-DPCCH (or EU-DPDCH) may use a channelization code of spreading factor (SF) 128. With BPSK modulation, the 2 ms TTI and fixed SF=128, up to 60 coded bits may be transmitted per sub-frame 300. Each slot 310 may include a specified field format, depending on what transmissions mode the UE 105 is in for scheduling transmission of packet data and/or high speed data in the uplink to the Node B 110. Regardless of the TTI chosen, the number of fields that are specified in a particular slot 310 of the sub-frame 300 may remain constant.

The EU-DPCCH may be configured for a UE operating in different transmission modes. Exemplary sub-frame structure and data fields of a EU-DPCCH in the case where a UE 105 is in a scheduled transmission mode, rate-controlled transmission mode and reporting mode is described in detail in co-pending '339 application; thus a detailed description is omitted for purposes of brevity. Accordingly, an EU-DPCCH may signal control information in the uplink to the Node B 110, regardless what transmission mode the UE 105 is in for scheduling of uplink transmissions, thus, the slots 310 of the EU-DPCCH (or EU-DPDCH) sub-frame 300 may have different field formats, as described in the co-pending '339 application.

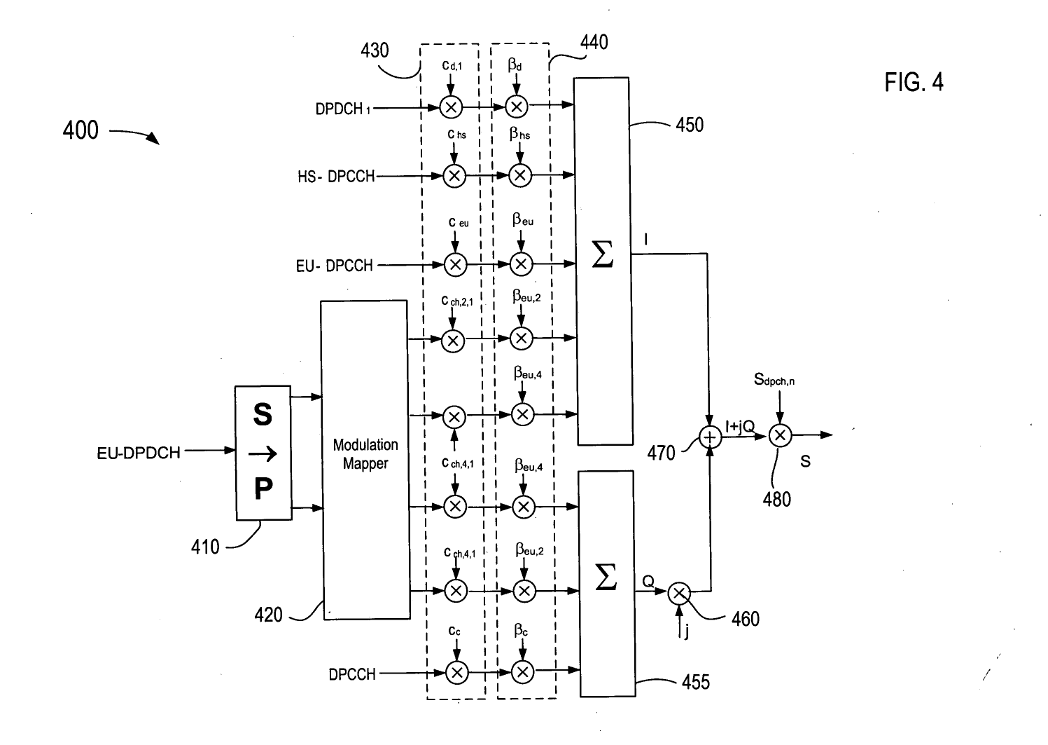

FIG. 4 illustrates spreading for uplink dedicated physical channels to illustrate a method of code multiplexing in accordance with the exemplary embodiments of the invention. The proposed channels for supporting EU-DCH services having been briefly described, methods of spreading or multiplexing data on the proposed EU channels with existing HS-DPCCH and DPDCH/DPCCHs may be explained with reference to FIG. 4.

In general, spreading is applied to the physical channels. Spreading may consist of two operations: channelization and scrambling. A channelization operation transforms every data symbol from each physical channel into a number of chips, thus increasing the bandwidth of the signal. The number of chips per data symbol may be referred to as the Spreading Factor (SF). The second operation is the scrambling operation, where a scrambling code is applied to the spread signal. With the channelization, data symbols on so-called I- and Q-branches may be independently multiplied with an Orthogonal Variable Spreading Factor (OVSF) code. With a scrambling operation, resultant spread signals on the I- and Q-branches may be further multiplied by a complex-valued scrambling code, where I and Q denote real and imaginary parts, respectively.

Referring now to FIG. 4, uplink spreading of DPCCHs, DPDCHs, HS-DPCCHs, EU-DPCCH and EU-DPDCHs, shown generally by arrow 400 may be described. The binary DPCCH (which carries control information for its corresponding DPDCHs), DPDCH (which may carry voice or data, for example), HS-DPCCH (carrying control information for downlink high speed data) and EU-DPCCH (carrying control information for its corresponding EU-DPDCHs) to be spread may be represented by real-valued sequences, i.e. the binary value “0” is mapped to the real value +1, the binary value “1” is mapped to the real value −1, and the value “DTX” (HS-DPCCH only) is mapped to the real value 0. The DPCCH may be spread to the chip rate by the channelization code cc. The n:th DPDCH, referred to as DPDCHN may be spread to the chip rate by the channelization code c_{d,n}. The HS-DPCCH may be spread to the chip rate by the channelization code cₕₛ. The EU-DPCCH may be spread to the chip rate by the channelization code cₑᵤ. Exemplary code allocations (e.g., codes used to spread the channel) for DPCCH, DPDCH and HS-DPCCH may be as described in Section 4.3.1.2 of 3GPP TS 25.213, V .5.3.0, March 2003, entitled “Spreading and Modulation” (FDD)(Release 5), for example. Exemplary code allocations for the EU-DPCCH may be similar to those described in TS 25.213 for the DPCCH and those for the EU-DPCCH similar to that described for the DPDCH in TS 25.213.

The EU-DPDCH may carry information consisting of complex-valued data symbols, data symbols that may have both real and imaginary parts. Additionally, the EU-DPDCH may be configured to support higher order modulation (such as QPSK, 16 QAM, 64 QAM, APSK, etc.) than modulation supported by the existing physical channels. Accordingly, if information on the EU-DPDCH is to be multiplexed with information on the other physical channels, the information, e.g., data symbols, are first serial-to-parallel converted at Serial-to-Parallel converter 410 and then mapped to one or more of an I branch or Q branch via modulation mapper 420. If an EU-DPDCH exists, then both the HS-DPCCH and EU-DPCCH should be mapped to the same branch (I or Q).

In case of QPSK, each pair of two consecutive real-valued symbols on the EU-DPDCH may be first serial-to-parallel converted at 410 and mapped at 420 to an I and Q branch. The definition of the modulation mapper 420 may vary depending on the modulation. For complex-valued modulations such as PSK, QAM, etc, the general rule is such that x number of bits are mapped to the I-branch with a given amplitude and phase, while the next x number of bits are mapped to the Q-branch in a similar fashion. In the case of QPSK, even and odd numbered symbols are mapped to the I and Q branch respectively. The I and Q branches are then both spread to the chip rate by the same real-valued channelization code C_{ch,SF,m}, where ch is the channel, SF is the spreading factor and m is the index to all valid channelization codes with the given spread factor, SF, shown as C_{ch,2,1} and C_{ch,4,1} in dotted block 430 of FIG. 4. The channelization code sequence should be aligned in time with the symbol boundary. In the case of 16QAM, a set of consecutive binary symbols may serial-to-parallel converted at 410 and then mapped to 16QAM by the modulation mapper 420. The I and Q branches may then both spread to the chip rate by the same real-valued channelization code C_{ch,16,m} (not shown). As described for QPSK, the channelization code sequence for 16QAM should be aligned in time with the symbol boundary.

In FIG. 4, one DPCCH, up to six parallel DPDCHs, and one HS-DPCCH can be transmitted simultaneously, i.e. 1≦n≦6. If an EU-DPCCH is being transmitted in lieu of a DPCCH, one HS-DPCCH and up to n EU-DPDCHs may be transmitted simultaneously. As an example, two complex-valued EU-DPDCHs can be formed, each having different channelization codes. One EU-DPDCH can be QPSK modulated using SF=2, e.g C_{ch,2,1} while the other EU-DPDCH can be 16QAM modulated using SF=4, e.g. C_{ch,4,1.} Both the I and Q branches for the same EU-DPDCH may be spread using the same real-valued channelization code. In another exemplary three complex-valued EU-DPDCHs could use the same spreading factor, e.g., SF=4; the same modulation, e.g., QPSK; but each EU-DPDCH could be spread by different channelization codes.

Thus, for each of the physical channels, real-valued and/or imaginary-valued spread signals are generated from the channel information due to channelization at block 430. After channelization, the real-valued (and imaginary-valued) spread signals may be weighted at block 440 by gain factors, β_{c} for DPCCH, β_{d} for all DPDCHs, βₕₛ for HS-DPCCH (if one is active), βₑᵤ for EU-DPCCH (if one is active), and β_{eu, SF} for all EU-DPDCHs. The β_{c} and β_{d} values may be signaled by higher layers or calculated as described in Section 5.1.2.5 of 3GPP TS 25.214, entitled Physical Layer Procedures (FDD), for example. At every instant in time, at least one of the values β_{c} and β_{d} may have the amplitude 1.0. The β_{c} β_{d} values may be quantized into 4 bit words, and have quantization steps as shown in Table 1.

TAABLE 1
The quantization of the gain parameters

| Signaling values for | Quantized amplitude ratios |
|---|---|
| β_{c} and β_{d} | β_{c} and β_{d} |
| 15 | 1.0 |
| 14 | 14/15 |
| 13 | 13/15 |
| 12 | 12/15 |
| 11 | 11/15 |
| 10 | 10/15 |
| 9 | 9/15 |
| 8 | 8/15 |
| 7 | 7/15 |
| 6 | 6/15 |
| 5 | 5/15 |
| 4 | 4/15 |
| 3 | 3/15 |
| 2 | 2/15 |
| 1 | 1/15 |
| 0 | Switch off |

Similar to β_{c} and β_{d} values of Table 1, at every instant in time, at least one of the values Bₑᵤ may have an amplitude 1.0 and may be quantized into a 4 bit word. Accordingly, the values in Table 1 are equally applicable to βₑᵤ. In the case of multiple EU-DPDCHs, each EU-DPDCH has a βₑᵤ which can be different.

The βₕₛ value may be derived from a power offset Δ_{ACK}, Δ_{NACK} and Δ_{CQI}, which are signaled by higher layers as described in Section 5.1.2.6 of 3GPP TS 25.214. The relative power offsets Δ_{ACK}, Δ_{NACK} and Δ_{CQI} are quantized into amplitude ratios as shown in Table 2.

TABLE 2
Th quantization of th pow r offs t

| Signalling values for Δ_{ACK}, Δ_{NACK} and Δ_{CQI} | Quantiz d amplitude ratios for ${10}^{( \frac{{Δ}_{HS - DPCCH}}{20} )}$ |
|---|---|
| 8 | 30/15 |
| 7 | 24/15 |
| 6 | 19/15 |
| 5 | 15/15 |
| 4 | 12/15 |
| 3 | 9/15 |
| 2 | 8/15 |
| 1 | 6/15 |
| 0 | 5/15 |

After the weighting at block 440, the signal streams of real-valued chips on the I-branch are summed at 450 and the streams of imaginary-valued chips on the Q-branch are summed at 455. The summed signal output at 455 is subject to phase rotation at 460. The signal streams output of summer 450 and at 460 are then summed and treated as a complex-valued signal or stream of chips (I+jQ) at adder 470.

This complex-valued signal may be scrambled by a complex-valued scrambling code, denoted as S_{dpch,n}, at multiplier 480. The scrambling code may be applied so as to be aligned with the radio frames, i.e. the first scrambling chip corresponds to the beginning of a radio frame. The code used for scrambling of the uplink physical channels may be of either long or short type. When the scrambling code is formed, different constituent codes may be used for the long and short type, such as is defined in Section 4.3.2.4 of TS 25.213, for example.

When at least one EU-DPDCH exists, both the HS-DPCCH and the EU-DPCCH should be mapped to the same branch. The HS-DPCCH and the EU-DPCCH are mapped to the I branch in the case that the maximum number of DPDCHs over all the Transport Format Combinations (TFCs), in the Transport Format Combination Set (TFCS, set of all services supported) (defined as N_{max-dpdch}) is even, and mapped to the Q branch otherwise. The I/Q mapping of HS-DPCCH or EU-DPCCH is not changed due to any frame-by-frame TFCI change or temporary TFC restrictions.

The exemplary embodiments of the present invention being thus described, it will be obvious that the same may be varied in many ways. For example, the method and/or system described herein may be implemented at different locations, such as the wireless unit, the base station, a base station controller and/or mobile switching center, and employed in conjunction with various multiple access schemes, such as CDMA and orthogonal frequency division multiple access OFDMA, for example. Such variations are not to be regarded as departure from the spirit and scope of the exemplary embodiments of the present invention, and all such modifications as would be obvious to one skilled in the art are intended to be included within the scope of the following claims.

1. A method of multiplexing information from a plurality of physical channels, comprising:
channel multiplexing information on the plurality of physical channels generate a code-multiplexed signal, the multiplexing including subjecting the information on the physical channels to a channelization operation, wherein information from at least one of the physical channels are serial-to-parallel converted and mapped to one or both of a first branch and a second branch for the channelization operation.

2. The method of claim 1, wherein the information includes control information and data for uplink transmission.

3. The method of claim 1, wherein
subjecting the information on the physical channels to a channelization operation includes generating one of real-valued (I) spread signals on the first branch and imaginary-valued (Q) spread signals on the second branch.

4. The method of claim 3, wherein subjecting the information on the physical channels to a channelization operation includes independently multiplying data symbols on the first branch and second branch with orthogonal variable spreading factor (OVSF) codes to generate the real-valued (I) spread signals on the first branch and the imaginary-valued (Q) spread signals on the second branch.

5. The method of claim 3, further comprising:
weighting the real-valued (I) spread signals and the imaginary-valued (Q) spread signals by given gain factors to generate weighted spread signals on the first and second branches.

6. The method of claim 5, further comprising: summing the weighted spread signals on the first and second branches to generate a complex-valued signal.

7. The method of claim 6, wherein the weighted spread signals on the second branch are weighted imaginary-valued (Q) spread signals, the method further comprising:
applying a phase rotation to the weighted imaginary-valued (Q) spread signals on the second branch.

8. The method of claim 6, further comprising:
applying a scrambling code to the complex-valued signal to generate the code-multiplexed signal.

9. The method of claim 8, wherein the applying includes scrambling the complex-valued signal with a complex-valued scrambling code so that a first scrambling chip of the complex-valued scrambling code corresponds to a beginning of a radio frame containing the complex-valued signal.

10. The method of claim 1, wherein the information that is serial-to-parallel converted and mapped to one of the first branch and second branch for channelization are data symbols from a dedicated physical data channel.

11. The method of claim 1, wherein
the plurality of physical channels includes a first control channel configured to support high speed downlink packet access (HSPDA) services, a second control channel configured to support enhanced uplink (EU) services, and a data channel configured to support enhanced uplink (EU) services, and
the first and second control channels are mapped to the same branch if the data channel configured to support enhanced uplink (EU) services is one of the channels to be subject to multiplexing.

12. A method of multiplexing information on a plurality of physical channels for uplink transmission, the plurality of physical channels including at least one data channel, comprising:
subjecting information on each of the physical channels to a channelization operation to generate one of real-valued (I) spread signals on an I branch and imaginary-valued (Q) spread signals on a Q branch, wherein data symbols from the data channel are serial-to-parallel converted and mapped to one of the I branch and Q-branch for channelization;
summing the spread signals on the I and Q branches to generate a complex-valued signal; and
applying a scrambling code to the complex-valued signal to generate a code-multiplexed signal for uplink transmission.

13. The method of claim 12, wherein the information includes control information and data for uplink transmission.

14. The method of claim 12, wherein
subjecting the information on the physical channels to a channelization operation includes generating one of real-valued (I) spread signals on the I branch and imaginary-valued (Q) spread signals on the Q branch.

15. The method of claim 14, wherein subjecting the information on the physical channels to a channelization operation includes independently multiplying data symbols on the I branch and Q branch with orthogonal variable spreading factor (OVSF) codes to generate the real-valued (I) spread signals on the I branch and the imaginary-valued (Q) spread signals on the Q branch.

16. The method of claim 14, further comprising:
weighting the real-valued (I) spread signals and the imaginary-valued (Q) spread signals by given gain factors to generate weighted spread signals on the I and Q branches, wherein the weighting step is performed prior to the summing step.

17. The method of claim 16, wherein the weighted spread signals on the Q branch are weighted imaginary-valued (Q) spread signals, the method further comprising:
applying a phase rotation to the weighted imaginary-valued (Q) spread signals on the Q branch.

18. The method of 12, wherein the applying includes scrambling the complex-valued signal with a complex-valued scrambling code so that a first scrambling chip of the complex-valued scrambling code corresponds to a beginning of a radio frame containing the complex-valued signal.

19. The method of claim 12, wherein the plurality of physical channels include a first control channel configured to support high speed downlink packet access (HSPDA) services and a second control channel configured to support enhanced uplink (EU) services, and the at least one data channel is configured to support enhanced uplink (EU) services.

20. The method of claim 19, wherein the first and second control channels are mapped to the same branch.

21. A method for uplink spreading a plurality of physical channels for uplink transmission, comprising:
subjecting information on the plurality of physical channels to a channelization operation to generate spread signals, where information on at least one of the physical channels is serial-to-parallel converted and mapped to one or both of a first and second branch before being subject to the channelization operation;
summing the spread signals to generate a complex-valued signal; and
scrambling the complex valued signal to generate a code-multiplexed signal for uplink transmission.
